(19) United States
(12) Patent Application Publication
(10) Pub. No.: US 2023/0011281 A1
(43) Pub. Date: Jan. 12, 2023

(54) FORECASTING FISHING CONDITIONS USING FORECASTED AND PAST WEATHER

(71) Applicant: BassForecat, LLC, Arlington, TX (US)

(72) Inventors: Mike Mehlmann, Arlington, VA (US); Mike Welsh, Downingtown, PA (US)

(21) Appl. No.: 17/811,553

(22) Filed: Jul. 8, 2022

Related U.S. Application Data
(60) Provisional application No. 63/219,555, filed on Jul. 8, 2021.

(51) Int. Cl. G01W 1/10; G01W 1/04; A01K 99/00

(52) U.S. Cl. CPC G01W 1/10; G01W 1/04; A01K 99/00

(57) ABSTRACT

A system and method for generating a location-specific, date-specific, numerical forecast indicative of future fishing conditions (e.g., bass fishing conditions). Because water is an insulator that is affected by weather conditions for longer than a single day, fishing conditions are affected by both the current weather conditions in a and weather conditions that occurred in that location in the recent past. Accordingly, uses a rules-based process that captures the specific weather conditions that affect fishing conditions over the specific time period that those weather conditions continue to have an effect.

### CROSS REFERENCE TO RELATED APPLICATIONS

This application claims priority to U.S. Prov. Pat. Appl. No. 63/219,555, filed Jul. 8, 2021, which is hereby incorporated by reference.

### BACKGROUND

Fishing conditions on each day in each location are affected by the weather and solunar conditions on that day. Additionally, because water is an insulator that is affected by weather conditions for longer than a single day, the fishing conditions in each location are also affected by the weather conditions that occurred in that location in the recent past.

### SUMMARY

Accordingly, disclosed is a system and method for generating a location-specific and date-specific forecast (a forecast rating) indicative of future fishing conditions based on past and forecasted weather conditions. In some embodiments, the forecast rating may also be generated based on solunar conditions. Additionally, the system may also generate a seasonal forecast characterizing fishing conditions on a specific date as being indicative of one of a number of predetermined fishing seasons (e.g., early fall, fall, late fall, winter, pre-spawn, spawn, post-spawn, summer, “dog days”, etc.). The system may also identify recommended bait for the specific forecasted fishing conditions identified by the system. The system may identify recommended bait for the forecasted fishing conditions in locations that include specific structures, such as wood, weeds, and rock. The system may also identify a recommended fishing rod, a recommended reel type, and/or a recommended line type for each recommended bait as identified by the system. The system may also identify a recommend presentation (e.g., slow, medium speed, fast) for the specific forecasted fishing conditions. Finally, the system may also identify a recommend fishing location (within a generic body of water) for the specific forecasted fishing conditions.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of a system for generating a forecast rating indicative of future fishing conditions according to an exemplary embodiment.

FIG. 2 is a flowchart illustrating a process for generating a forecast rating indicative of future fishing conditions according to an exemplary embodiment.

FIG. 3 is a flowchart illustrating the process of FIG. 2 in greater detail according to an exemplary embodiment.

FIG. 4 is a flowchart illustrating a process for generating a pressure adjustment according to an exemplary embodiment.

FIG. 5 is a flowchart illustrating a process for generating a past temperature adjustment and a temperature change adjustment according to an exemplary embodiment.

FIG. 6 is a flowchart illustrating a process for generating a wind adjustment according to an exemplary embodiment.

FIG. 7 is a flowchart illustrating a process for generating a sky adjustment according to an exemplary embodiment.

FIG. 8 is a flowchart illustrating a process for generating a moon adjustment according to an exemplary embodiment.

FIG. 9 is a flowchart illustrating a process for generating a seasonal forecast according to an exemplary embodiment.

FIG. 10 is a flowchart illustrating a process for identifying recommended bait, location, and/or presentation according to an exemplary embodiment.

FIG. 11 is a diagram illustrating recommended fishing locations according to an exemplary embodiment

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

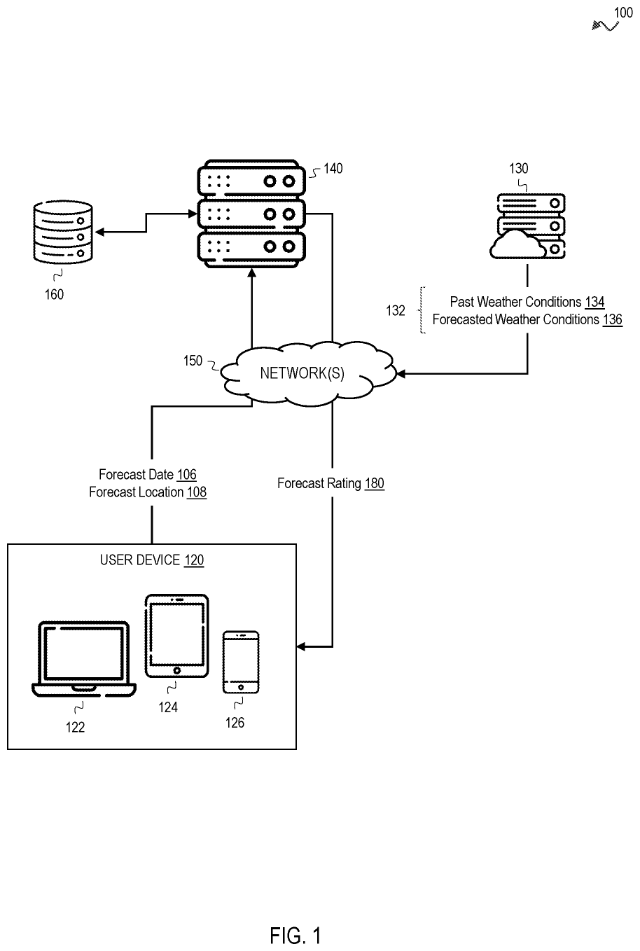

FIG. 1 is a diagram of a fishing forecast system 100 (e.g., a bass forecast system) according to an exemplary embodiment.

The system 100 may be realized by software stored on a server 140 that is accessible to a user via one or more computer network 150 (e.g., the Internet). For example, the system may provide a software application (e.g., a web-based application, a desktop application, a smartphone application, etc.) that is executable by a user device 120 (e.g., a desktop computer 122, a tablet 124, a smartphone 116, etc.) or accessibly by the user device 120 (e.g., via an application programming interface). The software application may include a user interface that provides functionality for a user to specify a forecast date 106 and a forecast location 108. If the user device 120 is location-enabled, the system 100 may also receive information indicative of the location of the user device 120 and determine the forecast location 108 based on the location of the user device 120.

As described in detail below, the system 100 generates a forecast rating 180 indicative of future fishing conditions in the forecast location 108 specified by the user on the forecast date 106 specified by the user based on the forecasted weather conditions 136 in the forecast location 108 for the forecast date 106 as well as the past weather conditions 134 in the forecast location 108 during a time period before the forecast date 106. However, users may specify a forecast date 106 that is days and even weeks in the future. In those instances, some or all of the relevant time period before the forecast date 106 may not have occurred yet. Therefore, some or all of the “past” weather conditions 134 may actually be forecasted weather conditions 136 that are forecasted to occur in the forecast location 108 on a future date that is before the forecast date 106.

While the system 100 may be used to generate a forecast rating 180 that is broadly indicative of the conditions for fishing any fish in the forecast location 108 on the forecast date 106, the system 100 is particularly well suited to generate a bass forecast rating 180 indicative of bass fishing conditions because the process 200 described below captures the specific weather conditions 132 that affects bass fishing conditions over the specific time period that those weather conditions 132 continue to have an effect.

To generate the forecast rating 180 as described below, the system 100 may receive weather data 132, for example from a third party 130 via the Internet 150. As mentioned above, the weather data 132 may include past weather conditions 134 and forecasted weather conditions 136. Those weather conditions 134 and 136 may include the average daily temperature, wind speed, sky condition (e.g., clear, mostly sunny, partly cloudy, mostly cloudy, cloudy, overcast, etc.), precipitation (e.g., rain showers, rain, thunderstorm, etc.), daily maximum atmospheric pressure, the time (e.g., hour) of the daily maximum atmospheric pressure, the daily minimum atmospheric pressure, the time (e.g., hour) of the daily minimum atmospheric pressure, etc. The weather data 134 may be received, for example, from a government agency (e.g., the U.S. National Weather Service), a private weather information provider (e.g., AccuWeather, Inc.), etc.

The system 100 may receive the weather conditions 132 used to generate a location-specific and date-specific forecast rating 180 by outputting the forecast location 108 and the forecast date 106 to a third party 130 and receiving the weather conditions 132 for the forecast location 108 and the forecast date 106. Alternatively, the system 100 may receive past weather conditions 134 and forecasted weather conditions 136 for a large number of locations and store them in a database 160. In those embodiments, the system 100 may identify the weather conditions 132 for the forecast location 108 and the forecast date 106 by retrieving them from the database 160 of the system 100.

The system may also receive solunar data (for example, a lunar calendar as described below) from a third party 130 via the one or more networks 150 (e.g., the Internet).

The server 140 may be any hardware computing device having a hardware computer processor suitably configured to perform the functions described herein. The server 140 stores instructions for performing those functions and the data described below in non-transitory computer readable storage media.

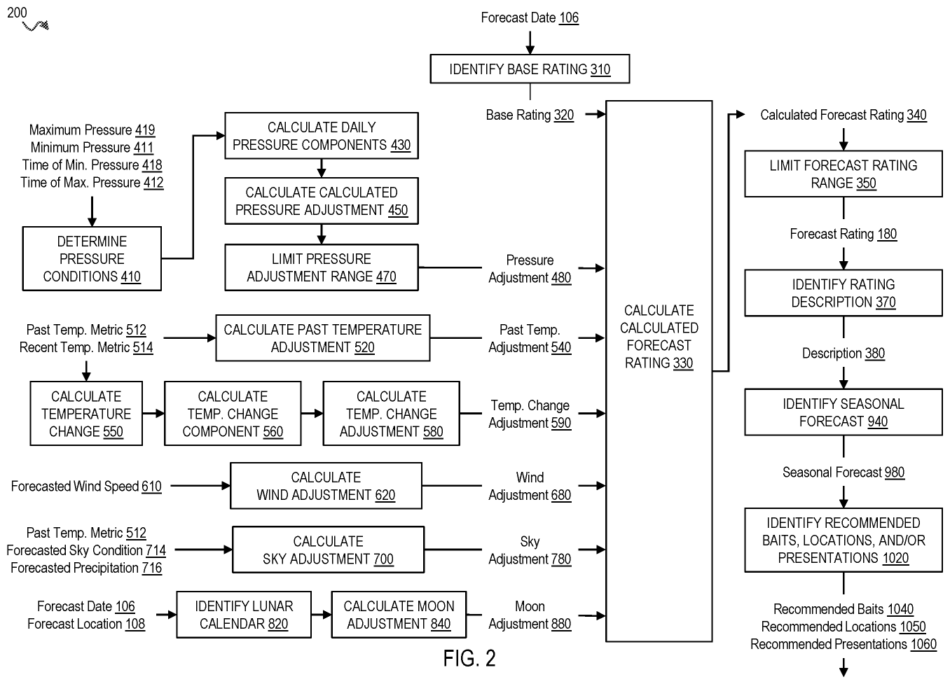

FIG. 2 is a flowchart illustrating a process 200 for generating the forecast rating 180 according to an exemplary embodiment.

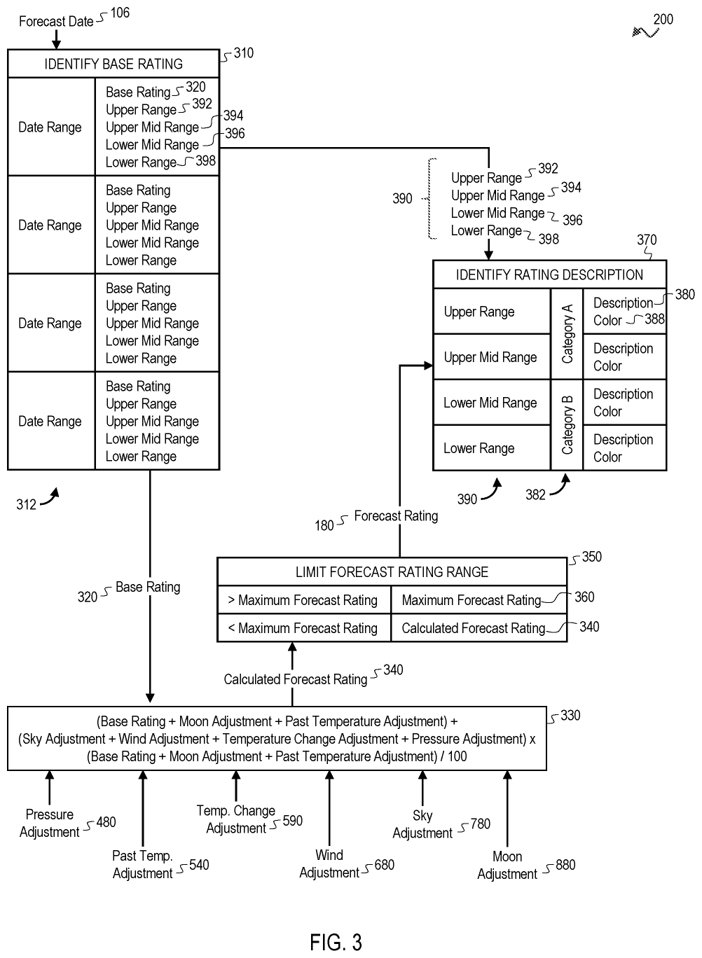

As described in detail below with reference to FIG. 3, a base rating 320 is identified in step 310 based on the forecast data 106 and a calculated forecast rating 340 is calculated in step 330. In some embodiments, the range of the forecast rating 180 may be limited in step 350. In some embodiments, a rating description 380 may be identified in step 370. In some embodiments, the calculated forecast rating 340 is calculated based on the base rating 320, a pressure adjustment 480, a past temperature adjustment 540, a temperature change adjustment 590, a wind adjustment 680, a sky adjustment 780, and a moon adjustment 880.

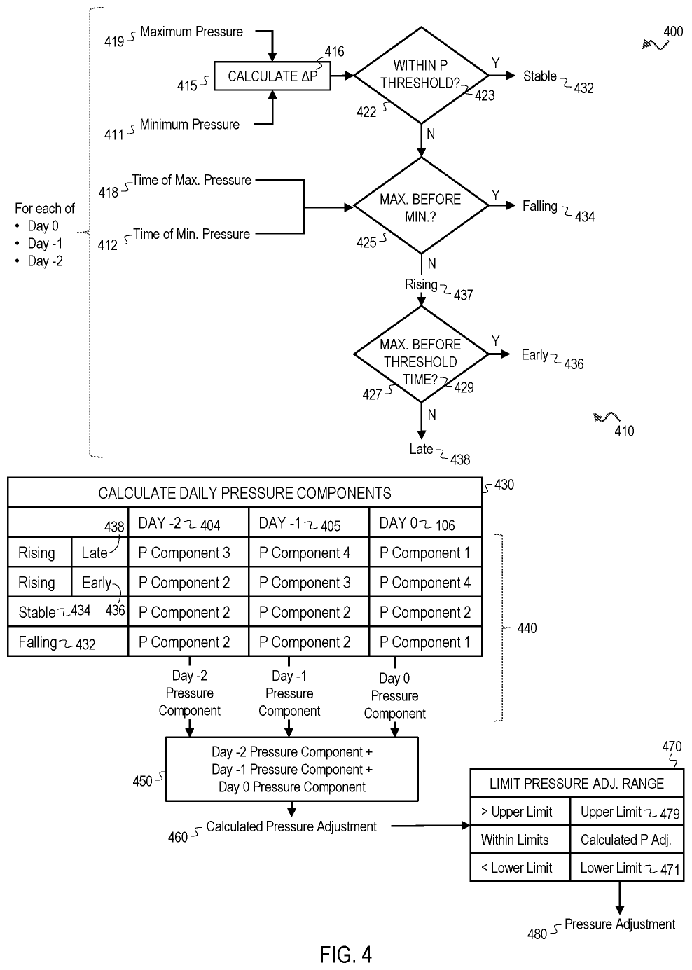

As described in detail below with reference to FIG. 4, the pressure adjustment 480 may be calculated by determining the pressure conditions (e.g., based on the maximum pressure 419, the minimum pressure 411, the time of day of the minimum pressure 412, and the time of day of the maximum pressure 418) during a time period preceding the forecast date 106 in step 410, calculating daily pressure components in step 430, calculating a calculated pressure adjustment in step 450, and limiting the range of the pressure adjustment 480 in step 470.

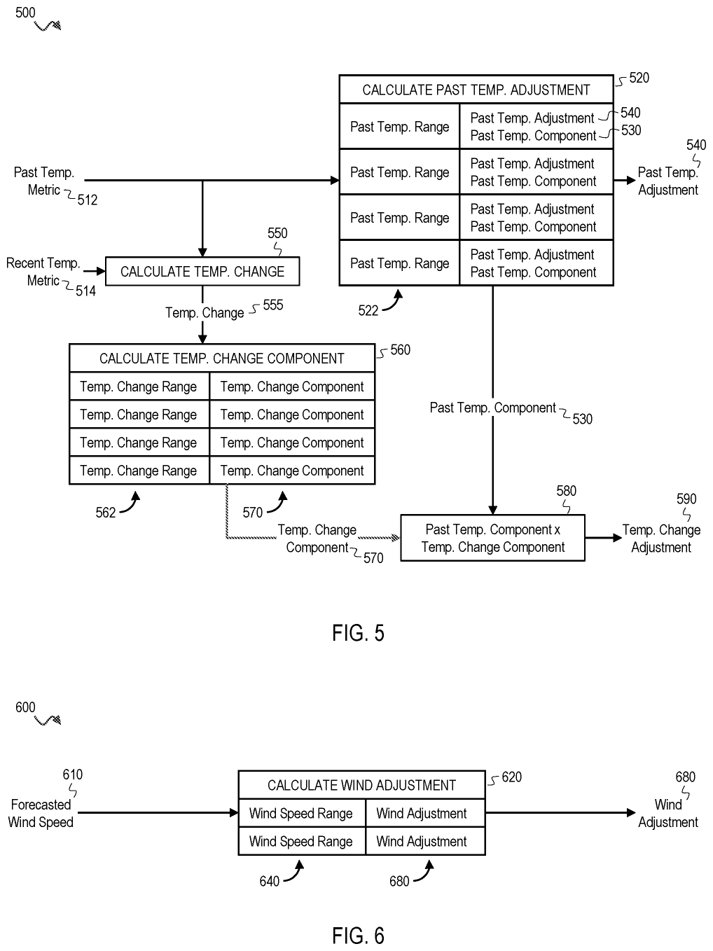

As described in detail below with reference to FIG. 5, the past temperature adjustment 540 may be calculated in step 520 based on a past temperature metric 512 (e.g., the average daily temperature over the 10 days prior to the forecast date 106) and a recent temperature metric 514 (e.g., the average daily temperature over the 3 days prior to the forecast date 106) for the forecast location 108. Additionally, the temperature change adjustment 590 may be calculated (using the past temperature metric 512 and the recent temperature metric 514) by calculating a temperature change in step 550, calculating a temperature change component in step 560, and calculating the temperature change adjustment 590 in step 580.

As described in detail below with reference to FIG. 6, the wind adjustment 680 may be calculated in step 620 based on the forecasted wind speed 610 in the forecast location 108 on the forecast date 106.

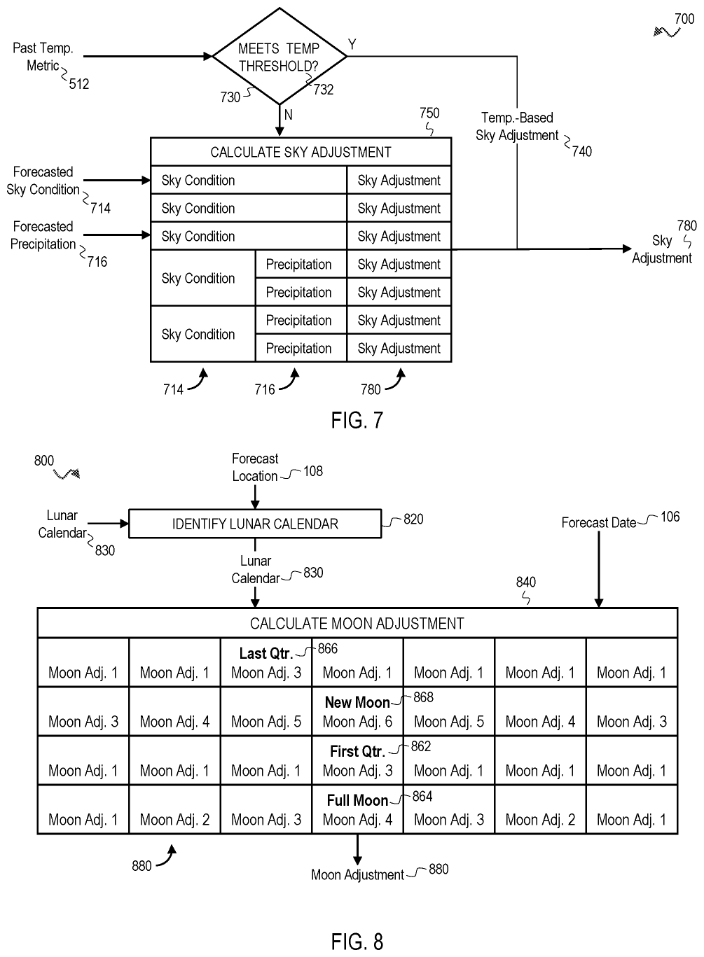

As described in detail below with reference to FIG. 7, the sky adjustment 780 may be calculated in step 720 based on the past temperature metric 512 and a forecasted sky condition 714 and forecasted precipitation in the forecast location 108 on the forecast date 106.

As described in detail below with reference to FIG. 8, the moon adjustment may be calculated based on the forecast location 108 and the forecast date 106 by identifying a lunar calendar in step 820 and calculating the moon adjustment 880 in step 840.

FIG. 3 illustrates a high-level overview of the process 200 for generating the forecast rating 180 according to an exemplary embodiment.

As shown in FIG. 3, the system 100 may first identify the base rating 320 for the forecast date 106 in step 310. For example, the system 100 may store a plurality of predetermined base ratings 320, each associated with one of a plurality of predetermined date ranges 312, and identify the base rating 320 for the forecast date 106 by selecting the predetermined base rating 320 associated with the predetermined date range 312 that includes the forecast date 106.

To generate the calculated forecast rating 340 for the forecast location 108 and forecast date 106 in step 330, the system 100 may adjust the base rating 320 based on the forecasted weather conditions 136 and past weather conditions 134 for the forecast location 108 and the forecast date 106. Therefore, as briefly mentioned above and described in detail below, the system 100 may calculate a pressure adjustment 480 (described below with reference to FIG. 4), temperature adjustments 540 and 590 (described below with reference to FIG. 5), a wind adjustment 680 (described below with reference to FIG. 6), and a sky adjustment 780 (described below with reference to FIG. 7). The system 100 may also adjust the base rating 100 based on the solunar conditions in the forecast location 108 on the forecast date 106, for example by calculating a moon adjustment 880 (as described below with reference to FIG. 8).

The system may store a maximum forecast rating 360 and adjust the calculated forecast rating 340 in step 360, for example by making the forecast rating 180 equal to the maximum forecast rating 360 if the calculated forecast rating 340 is greater than the maximum forecast rating 360. In some embodiments, the system 100 may also store a minimum forecast rating and similarly make the forecast rating 180 equal to the minimum forecast rating if the calculated forecast rating 340 is below the minimum forecast rating. The system 100 may further impose upper and/or lower limits on any of the other calculated numerical metrics described herein.

Having generated a (numerical) forecast rating 180 for the forecast location 108 and the forecast date 106, the system 100 may also identify a description 380 describing the fishing conditions indicated by the forecast rating 180 in step 370. For example, the system 100 may store a plurality of predetermined descriptions 380 (e.g., “Tough”, “Fair”, “Good”, “Epic”), each associated with a predetermined numerical range 390 (e.g., an upper range 392, an upper middle range 394, a lower middle range 396, and a lower range 398, etc.), and identify the relevant description 380 for the forecast rating 180 by selecting the predetermined description 380 associated with the predetermined numerical range 390 that includes the forecast rating 180.

Depending on the time of year, however, different descriptions 380 may be applicable to the fishing conditions indicated by the same forecast rating 180. For instance, the same forecast rating 180 may be below average during one time of year while being significantly above average for another time of year. Therefore, as shown in FIG. 3, for each of a plurality of predetermined date ranges (e.g., the predetermined date ranges 312 used to identify the base rating 320 in step 310), the system 100 may store a set of predetermined numerical ranges 390 (e.g., an upper range 392, an upper middle range 394, a lower middle range 396, and a lower range 398). The system 100 may then identify the relevant description 380 for the forecast rating 180 by identifying the set of predetermined numerical ranges 390 associated with the date range 312 that includes the forecast date 106 and selecting the predetermined description 380 associated with the predetermined numerical range 390 that includes the forecast rating 180.

Each predetermined description 180 may also be associated with a predetermined color 388 used by the system 100 when displaying the forecast rating 180 and/or description 380 to the user, for example via a graphical user interface of the user device 120.

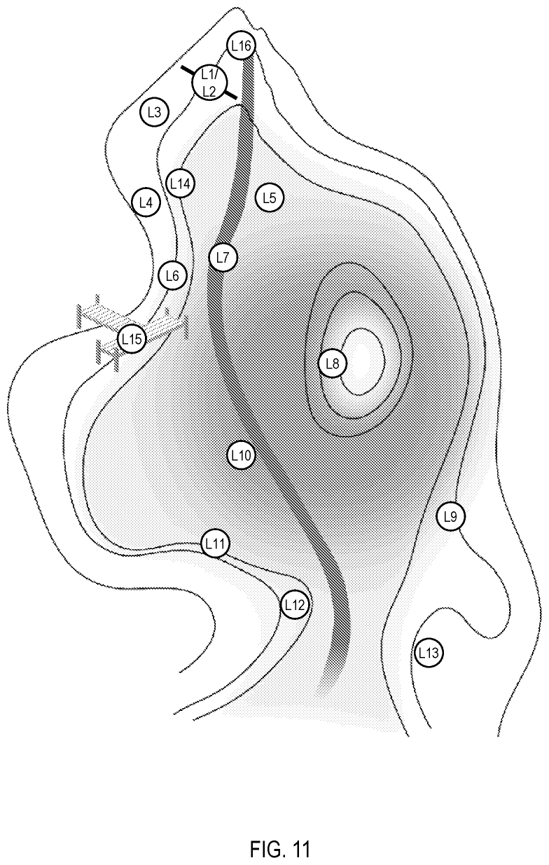

The system 100 may also store a plurality of predetermined categories 382, each associated with one or more of the predetermined numerical ranges 390. The category 382 may be broadly indicative of the fishing conditions indicated by the forecast rating 180 and may be used by the system 100, for example, to identify recommended baits, recommended fishing locations, and/or recommended presentations (as described below with reference to FIGS. 10-11) for the fishing conditions indicated by the forecast rating 180.

FIG. 4 is a flowchart illustrating a process 400 for generating a pressure adjustment 480 according to an exemplary embodiment.

As shown in FIG. 4, a calculated pressure adjustment 460 may be the sum of pressure components 440 indicative of the barometric pressure on the forecast date 106 (Day 0), the day before the forecast date 405 (Day −1), and two days prior to the forecast date 404 (Day −2), etc. For each day (Day 0, Day −1, Day −2, etc.), the system 100 may calculate the pressure component 440 using the maximum atmospheric pressure 419, the minimum atmospheric pressure 411, the time 418 (e.g., hour) of the maximum atmospheric pressure 419, and the time 412 (e.g., hour) of the minimum atmospheric pressure 411 on that day.

Each of the daily pressure components 440 may be based on pressure conditions (e.g., whether the atmospheric pressure was (or is forecasted to be) stable 432, falling 434, or rising 436 on that day) determined using the process 410. The system 100 may calculate the difference (ΔP 416) between the maximum atmospheric pressure 419 and the minimum atmospheric pressure 411 in step 415 determine that the atmospheric pressure was (or is forecasted to be) stable 432 in step 422 if the difference (ΔP) 416 is within a predetermined pressure threshold 423. The system 100 may determine that the atmospheric pressure was (or is forecasted to be) falling 434 in step 425 if the time 418 of the maximum atmospheric pressure 419 is before the time 412 of the minimum atmospheric pressure 411. On the other hand, the system 100 may determine that the atmospheric pressure was (or is forecasted to be) rising 437 in step 425 if the time 418 of the maximum atmospheric pressure 419 is after the time 412 of the minimum atmospheric pressure 411.

In the case of rising atmospheric pressure 437, the pressure component may also depend on whether the maximum atmospheric pressure 419 occurred (or is forecasted to occur) early or late in the day. To determine whether the maximum atmospheric pressure 419 occurred (or is forecasted to occur) early or late in the day, the system 100 may determine in step 427 whether the time 418 of the maximum atmospheric pressure 418 is before a predetermined time threshold 429.

The system 100 may store a plurality of predetermined pressure components 440 for each day (e.g., Day 0, Day −1, Day −2, etc.), pressure condition (e.g., falling 432, stable 434, or rising 437), and (in the case of rising pressure 437, for example) the time of day of the maximum pressure (e.g., early 436 or late 438). The system 100 may store different predetermined pressure components 440 for the same pressure condition depending on the day 106, 405, or 404. For example, falling pressure 432 may have a different impact on fishing conditions on the forecast day 106 (Day 0) than falling pressure 432 occurring on either of the previous days 405 or 404. At the same time, the system 100 may store and use the same predetermined pressure component 440 for different conditions on different days. For example, the same predetermined pressure component 440 may be used to characterize rising pressure early 436 on the forecast date 106 (Day 0) or late 438 on the day before 405 (Day −1).

To calculate the pressure component 440 for each day, the system may select the predetermined pressure component 440 associated with the pressure condition (and time of day of the maximum pressure) determined for that day. Again, the system 100 may generate the calculated pressure adjustment 460 in step 450 by calculating the sum of the pressure components 440 for each day. The system 100 may compare the calculated pressure adjustment 460 to an upper limit 479 and/or a lower limit 471. If the calculated pressure adjustment 460 is within the range between the upper limit 479 and the lower limit 471, the system 100 may generate the pressure adjustment 480 by outputting the calculated pressure adjustment 460. In some embodiments, however, if the calculated pressure adjustment 460 is greater than the upper limit 479 (or less than the lower limit 471), then the system 100 may generate the pressure adjustment 480 by outputting the upper limit 479 (or the lower limit 471).

FIG. 5 is a flowchart illustrating a process 500 for generating temperature adjustments according to an exemplary embodiment.

As shown in FIG. 5, the temperature adjustments generated by the system 100 may include a past temperature adjustment 540 and a temperature change adjustment 590. The past temperature adjustment 400 may be calculated using a past temperature metric 512 (e.g., the average daily temperature over the 10 days prior to the forecast date). The temperature change adjustment 590 may be calculated using the temperature change 555, which is calculated in step 550 by taking the difference between the past temperature metric 512 and a recent temperature metric 514 (e.g., the average daily temperature over the 3 days prior to the forecast date). The past temperature metric 512 and the recent temperature metric 514 may be any weather metric indicative of the temperature over any time period. However, in order to capture the change in temperature during the time period prior to the forecast date 106, the past temperature metric 512 is indicative of the temperature over a longer time period than the recent temperature metric 514.

To calculate the past temperature adjustment 540 in step 520, the system may store a plurality of predetermined past temperature adjustments 540, each associated with a predetermined past temperature range 522, and identify the past temperature adjustment 540 for the forecast location 108 and the forecast date 106 by selecting the predetermined past temperature adjustment 540 that is associated with the predetermined past predetermined range 512 that includes the past temperature metric 512 for the forecast location 108 and the forecast date 106.

The temperature change adjustment 590 may be the product of a past temperature component 530 and a temperature change component 570. To calculate the past temperature component 530, the system 100 may similarly store a plurality of predetermined past temperature components 530, each associated with one of the predetermined past temperature ranges 522, and identify the past temperature component 530 for the forecast location 108 and the forecast date 106 by selecting the predetermined past temperature component 530 that is associated with the predetermined past predetermined range 522 that includes the past temperature metric 512 for the forecast location 108 and the forecast date 106.

To calculate the temperature change component 570 in step 560, the system may store a plurality of predetermined temperature change components 570, each associated with a predetermined temperature change range 562, and identify the temperature change component 570 for the forecast location 108 and the forecast date 106 by selecting the predetermined temperature change component 570 that is associated with the predetermined temperature change range 562 that includes the temperature change 555 for the forecast location 108 and the forecast date 106.

FIG. 6 is a flowchart illustrating a process 600 for generating a wind speed adjustment 680 according to an exemplary embodiment.

As shown in FIG. 6, the wind speed adjustment 680 is calculated based on the forecasted wind speed 610 in the forecast location 108 for the forecast date 106.

To calculate the wind speed adjustment 680, the system 100 may store a plurality of predetermined wind speed adjustments 680, each associated with a predetermined wind speed range 640, and identify the wind speed adjustment 680 for the forecast location 108 and the forecast date 106 by selecting the predetermined wind speed adjustment 680 that is associated with the predetermined wind speed range 640 that includes the forecasted wind speed 610 in the forecast location 108 for the forecast date 106.

FIG. 7 is a flowchart illustrating a process 720 for generating a sky adjustment 780 according to an exemplary embodiment.

As shown in FIG. 7, the sky adjustment 480 may be calculated based on the forecasted sky condition 714 in the forecast location 108 for the forecast date 106, the forecasted precipitation 716 in the forecast location 108 for the forecast date 106, and the past temperature metric 512 (indicative of the temperature in the forecast location over the time period prior to forecast date 106, for example as described above).

To calculate the sky adjustment 780, the system may store a sky adjustment table 750 having a plurality of predetermined sky adjustments 780, each associated with a sky condition 714 (e.g., clear, mostly sunny, partly cloudy, mostly cloudy, cloudy, overcast, etc.) and identify the sky speed adjustment 780 for the forecast location 108 and the forecast date 106 by selecting the predetermined sky adjustment 780 that is associated with the forecasted sky condition 714 in the forecast location 108 for the forecast date 106. In some instances, the system 100 may store multiple predetermined sky adjustments 780 associated with the same sky condition 714, each associated with a precipitation type 716 (e.g., rain showers, rain, thunderstorm, etc.). In those instances, the system 100 may identify the sky speed adjustment 780 for the forecast location 108 and the forecast date 106 by selecting the predetermined sky adjustment 780 that is associated with the forecasted sky condition 714 and the forecasted precipitation type 716 in the forecast location 108 on the forecast date 106.

In some embodiments, the system 100 may also store a predetermined temperature-based sky adjustment 740 and compare a past temperature metric 512 (calculated, for example, as described above with reference to FIG. 3) to a predetermined temperature threshold 732 in step 730. In those embodiments, if the past temperature metric 512 for the forecast location 108 and the forecast date 106 meets the predetermined temperature threshold 732, the system 100 may generate the sky adjustment 780 for the forecast location 108 and the forecast date 106 by selecting the predetermined temperature-based sky adjustment 740 (regardless of the forecasted sky condition 714 and/or the forecasted precipitation type 716 in the forecast location 108 and the forecast date 106).

FIG. 8 is a flowchart illustrating a process 800 for generating a moon adjustment according to an exemplary embodiment.

As shown in FIG. 8, the system 100 may compare the forecast date 106 to a lunar calendar 830 indicative of moon phases in the forecast location 106 in step 840. The lunar calendar 830 may include the dates of certain lunar events that are closest to the forecast date 106, for example including a new moon 868, a full moon 864, a first quarter moon 862 (sometimes referred to as a half moon), and a last quarter moon 866 (also sometimes referred to as a half moon).

The system 100 may store a plurality of predetermined moon adjustments 880, each associated with one or more dates of the lunar calendar 830. As shown in FIG. 8, for example, the system may store a predetermined moon adjustment 880 (moon adjustment 6) associated the date of the new moon 868 on the lunar calendar 830, another predetermined moon adjustment 880 (moon adjustment 5) that is associated with the dates of the lunar calendar 830 that are 1 day away from the new moon 868, another predetermined moon adjustment 880 (moon adjustment 4) that is associated with the dates of the lunar calendar 830 that are 2 days away from the new moon 868 and also associated with the date of the full moon 864 on the lunar calendar 830, etc. The system 100 may then calculate the moon adjustment 880 for the forecast date 106 in forecast location 108 by selecting the predetermined moon adjustment 800 associated with the distance between the forecast date 106 and the lunar events on the lunar calendar 830 for the forecast location 108.

To compare the forecast date 106 to the lunar calendar 830 for the forecast location 108, the system 100 may output the forecast location 108 to a third party 130 via the one or more networks 150 (e.g., via the Internet), receive the lunar calendar 830 for the forecast location 108 from the third party 130 in step 820, and compare the forecast date 106 and the lunar events on the lunar calendar 830 in step 840. In other embodiments, the system 100 may output the forecast location 108 and the forecast date 106 to the third party 130 and receive, from the third party 130 as calculated by the third party 130, the distance between the forecast date 106 and the lunar events on the lunar calendar 830 for the forecast location 108.

Referring back to FIG. 2, the system 100 may generate the calculated forecast rating 340 for the forecast location 108 and the forecast date 106 by adjusting the base rating 320 (described above with reference to FIG. 3) based on the pressure adjustment 480 (described above with reference to FIG. 4), the past temperature adjustment 540 and the temperature change adjustment 590 (described above with reference to FIG. 5), the wind adjustment 680 (described above with reference to FIG. 6), the sky adjustment 780 (described above with reference to FIG. 7), and the moon adjustment 880 (described above with reference to FIG. 8).

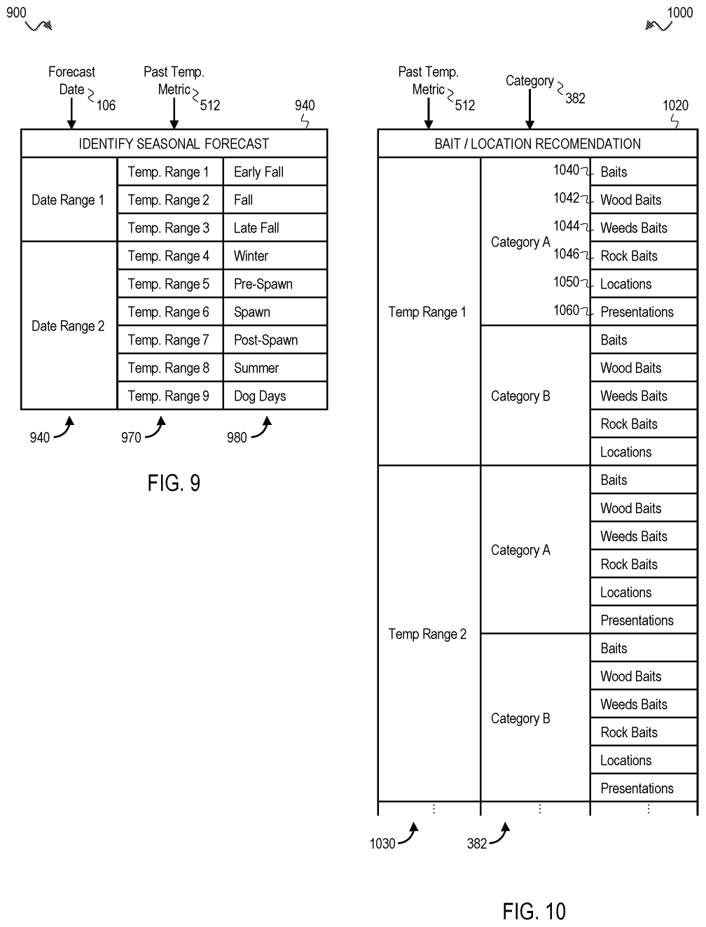

FIG. 9 is a flowchart illustrating a process 900 for generating a seasonal forecast 980 characterizing fishing conditions on the forecast date 106 as indicative of one of a number of predetermined fishing seasons (e.g., early fall, fall, late fall, winter, pre-spawn, spawn, post-spawn, summer, “dog days”, etc.) according to an exemplary embodiment.

As shown in FIG. 9, the seasonal forecast 980 may be broadly based on the forecast date 106 and specifically based on the past temperature metric 512 indicative of the temperature in the forecast location 108 over the time period prior to forecast date 106 (calculated, for example, as described above with reference to FIG. 5).

The system 100 may store a plurality of predetermined fishing seasons 980, each associated with one of a plurality of predetermined date ranges 940 and one of a plurality of predetermined temperature ranges 970. The system 100 may generate a seasonal forecast 980 for the forecast date 106 by selecting the predetermined fishing season 980 associated with the predetermined date range 940 that includes the forecast date 106 and the predetermined temperature range 970 that includes the past temperature metric 512 calculated for the forecast date 106.

FIG. 10 is a flowchart illustrating a process 100 for identifying recommended baits 140, recommended fishing locations 1060, and/or recommended presentations 1060 for forecasted fishing conditions according to an exemplary embodiment. FIG. 11 is a diagram of a generic body of water according to an exemplary embodiment.

The system 100 may store information identifying each of a plurality of baits 1040, for example a name, a description, a universal resource location (URL), etc. The system 100 may also store a plurality of presentations 1060 (e.g., slow, medium speed, fast). The system 100 may also store a plurality of distinct fishing locations 1050 that are commonly found in bodies of water. For example, the system 100 may store an image of a generic body of water (e.g., as shown in FIG. 11) that includes generic locations 1050 indicative of distinct fishing locations that commonly found in bodies of water. As shown, for example, in FIG. 11, the fishing locations may include:
L1. “Migration routes to spawning areas”
L2. “Migration routes from spawning areas”
L3. “Spawning areas”
L4. “Flats near spawning areas”
L5. “Creek channel mouths”
L6. “Secondary points”
L7. “Creek channels”
L8. “Humps”
L9. “Steep banks and bluffs”
L10. “Main lake”
L11. “Dropoffs/ledges”
L12. “Points”
L13. “Flats”
L14. “Transition banks”
L15. “Docks and marinas”
L16. “Backs of creeks”

As described above with reference to FIG. 3, the system 100 generates a forecast rating 180 indicative of the forecasted fishing conditions in the forecast location 108 on the forecast date 106. The system 100 may also identify a category 383, broadly indicative of the fishing conditions indicated by the forecast rating 180, by comparing the forecast rating 180 to a set of numerical ranges 390. Those numerical ranges 390 may vary depending on the forecast date 106 because fishing conditions may be characterized differently depending on the time of year.

As shown in FIG. 10, the system 100 may identify recommended baits 1040, recommended fishing locations 1050, and/or recommended presentations 1060 for the forecasted fishing conditions in step 1020 based on the past temperature metric 512 indicative of the temperature in the forecast location 108 over the time period prior to forecast date 106 (for example, as described above with reference to FIG. 5) and the category 582 indicative of the fishing conditions indicated by the forecast rating 382 (identified, for example, as described above with reference to FIG. 3).

For example, for each of a plurality of predetermined past temperature ranges 1030 and each of the plurality of categories 382, the system 100 may store a predetermined subset of the plurality of baits 1040, a predetermined subset of the fishing locations 1050, and a predetermined subject of the plurality of presentations 1060. The system 100 may then identify recommended baits 1040, recommended fishing locations 1050, and/or recommended presentations 1060 for the forecasted fishing conditions 180 in the forecast location 108 by identifying the predetermined subset of baits 1040, the predetermined subset of fishing locations 1050, and/or the predetermined subset of presentations 1060 associated with the predetermined past temperature range 1030 that includes the past temperature metric 512 in the forecast location 108 on the forecast date 106 and the category 382 indicative of the fishing conditions indicated by the forecast rating 180 for the forecast location 108 and the forecast date 106.

For each predetermined past temperature range 1030 and category 382, the system 100 may further store a predetermined subset 1042 of the baits 1040 for fishing in locations 1050 that include wood, a predetermined subset 1044 of the baits 1040 for fishing in locations 1050 that include weeds, and/or a predetermined subset 1046 of the baits 1040 for fishing in locations 1050 that include rock. In those embodiments, the system 100 may identify recommended baits 1040 for the forecasted fishing conditions in the forecast location 108 by identifying the predetermined wood baits 1042, the predetermined weeds baits 1044, and/or the predetermined rock baits 1066 associated with the predetermined past temperature range 1030 that includes the past temperature metric 512 in the forecast location 108 on the forecast date 106 and the category 382 indicative of the fishing conditions indicated by the forecast rating 180 for the forecast location 108 and the forecast date 106.

For each of the plurality of baits 1040, the system 100 may also store a recommended type of fishing rod, a recommended type of fishing reel, a recommended type of fishing line, and/or a description of a recommended method of fishing with that bait. Accordingly, the system may be configured to identify a recommended type of fishing rod, a recommended type of fishing reel, a recommended type of fishing line, and/or a recommended fishing method for fishing in the fishing conditions indicated by the forecast rating 180 for the forecast location 108 and the forecast date 106.

While the system 100 may be used to generate a forecast rating 180 that is broadly indicative of the conditions for fishing any fish in the forecast location 108 on the forecast date 106, the system 100 described above is particularly well suited to generate a bass forecast rating 180 indicative of the bass fishing conditions because the process 200 described above captures the specific weather conditions 132 that affects bass fishing conditions over the specific time period that those weather conditions 132 continue to have an effect. As described above, the system 100 identifies a number of relevant parameters by storing thresholds and/or ranges and comparing current and/or forecasted weather data 132 (and, in some embodiments, solunar data) to those thresholds and/or ranges. The system may do so, for example, using look-up tables, formulas, if-then statements, etc. While preferred embodiments have been described above, those skilled in the art who have reviewed the present disclosure will readily appreciate that other embodiments can be realized within the scope of the invention. Accordingly, the present invention should be construed as limited only by any appended claims.

1. A method of generating a bass forecast rating indicative of bass fishing conditions in a forecast location on a forecast date, the method comprising:
identifying a base rating based on the forecast date;
calculating a pressure adjustment by:
identifying atmospheric pressure conditions in the forecast location on a plurality of dates that include and immediately precede the forecast date;
identifying a pressure component for each of the plurality of dates based on the identified atmospheric pressure conditions in the forecast location on date;
calculating the pressure adjustment based on the identified pressure components for each of the dates that include and immediately precede the forecast date;
identifying a past temperature adjustment and a past temperature component based on a past temperature metric indicative of temperatures in the forecast location over a first time period preceding the forecast date;
calculating a temperature change based on the past temperature metric and a recent temperature metric that is indicative of temperatures in the forecast location over a second time period preceding the forecast date, wherein the second time period is shorter than the first time period;
identifying a temperature change component based on the calculated temperature change;
calculating a temperature change adjustment based on the identified past temperature component and the identified temperature change component;
identifying a wind adjustment based on a forecasted wind speed in the forecast location on the forecast date;
identifying a sky adjustment based on a forecast sky condition in the forecast location on the forecast date, a forecasted precipitation type in the forecast location on the forecast date, and/or the past temperature metric; and
calculating the bass forecast rating indicative of the bass fishing conditions in the forecast location on the forecast date by adjusting the identified base rating based on the calculated pressure adjustment, the identified past temperature adjustment, the calculated temperature change adjustment, the identified wind speed adjustment, and the identified sky adjustment.

2. The method of claim 1, wherein the bass forecast rating is calculated by:
multiplying the sum of the identified base rating and the identified past temperature adjustment by the sum of the identified sky adjustment, the identified wind adjustment, the calculated past change adjustment, and the calculated pressure adjustment; and
adding the sum of the identified base rating and the calculated past temperature adjustment.

3. The method of claim 1, wherein identifying atmospheric pressure conditions in the forecast location on each of the plurality of dates that include and immediately precede the forecast date comprises:
determining whether the atmospheric pressure is stable by comparing the difference between the maximum atmospheric pressure and the minimum atmospheric to a predetermined pressure threshold; and
determining whether the atmospheric pressure is rising or falling by comparing the time of the maximum atmospheric pressure and time of the minimum atmospheric.

4. The method of claim 3, wherein identifying atmospheric pressure conditions in the forecast location on each of the plurality of dates that include and immediately precede the forecast date further comprises:
determining whether the atmospheric pressure is rising early or late by comparing the time of the maximum atmospheric pressure to a predetermined threshold time.

5. The method of claim 1, wherein the calculated pressure adjustment is calculated by adding each of the identified pressure components for each of the plurality of dates that include and immediately precede the forecast date.

6. The method of claim 1, wherein the calculated pressure adjustment is further calculated by:
comparing the calculated pressure adjustment to an upper limit and a lower limit;
limiting the calculated pressure adjustment to conform to the range between the upper limit and the lower limit.

7. The method of claim 1, wherein the identified sky adjustment is identified by:
selecting a predetermined temperature-based sky adjustment in response to a determination that the past temperature metric for the forecast location and the forecast date is equal to or exceeds a predetermined temperature threshold;
selecting a predetermined sky adjustment associated with the forecasted sky condition and/or the forecasted precipitation condition in the forecast location on the forecast date in response to a determination that the past temperature metric for the forecast location and the forecast date does is not equal to or exceed the predetermined temperature threshold.

8. The method of claim 1, wherein the bass forecast rating is further calculated by:
comparing the calculated bass forecast rating to a predetermined maximum forecast rating; and
selected limiting the predetermined maximum bass forecast rating in response to a determination that the calculated bass forecast rating exceeds the predetermined maximum bass forecast rating.

9. The method of claim 1, further comprising:
identifying a moon adjustment by calculating a difference between the forecast date a lunar event in the forecast location and identifying the moon adjustment based on the calculated difference between the forecast date the lunar event in the forecast location,
wherein the identified base rating is further adjusted based on the identified moon adjustment.

10. The method of claim 9, wherein the bass forecast rating is calculated by:
multiplying the sum of the identified base rating, the identified moon adjustment, and the identified past temperature adjustment by the sum of the identified sky adjustment, the identified wind adjustment, the calculated past change adjustment, and the calculated pressure adjustment; and
adding the sum of the identified base rating, the identified moon adjustment, and the calculated past temperature adjustment.

11. A system for generating a bass forecast rating indicative of bass fishing conditions in a forecast location on a forecast date, the system comprising:
non-transitory computer-readable storage media that stores forecasted weather conditions and past weather conditions for the forecast location and the forecast date; and
a hardware computer processing unit that:
identifies a base rating based on the forecast date;
calculates a pressure adjustment by:
identifying atmospheric pressure conditions in the forecast location on a plurality of dates that include and immediately precede the forecast date;
identifying a pressure component for each of the plurality of dates based on the identified atmospheric pressure conditions in the forecast location on date;
calculating the pressure adjustment based on the identified pressure components for each of the dates that include and immediately precede the forecast date;
identifies a past temperature adjustment and a past temperature component based on a past temperature metric indicative of temperatures in the forecast location over a first time period preceding the forecast date;
calculates a temperature change based on the past temperature metric and a recent temperature metric that is indicative of temperatures in the forecast location over a second time period preceding the forecast date, wherein the second time period is shorter than the first time period;
identifies a temperature change component based on the calculated temperature change;
calculates a temperature change adjustment based on the identified past temperature component and the identified temperature change component;
identifies a wind adjustment based on a forecasted wind speed in the forecast location on the forecast date;
identifies a sky adjustment based on a forecast sky condition in the forecast location on the forecast date, a forecasted precipitation type in the forecast location on the forecast date, and/or the past temperature metric; and
calculates the bass forecast rating indicative of the bass fishing conditions in the forecast location on the forecast date by adjusting the identified base rating based on the calculated pressure adjustment, the identified past temperature adjustment, the calculated temperature change adjustment, the identified wind speed adjustment, and the identified sky adjustment.

12. The system of claim 11, wherein the calculated bass forecast rating is calculated by:
multiplying the sum of the identified base rating and the identified past temperature adjustment by the sum of the identified sky adjustment, the identified wind adjustment, the calculated past change adjustment, and the calculated pressure adjustment; and
adding the sum of the identified base rating and the calculated past temperature adjustment.

13. The system of claim 11, wherein the atmospheric pressure conditions in the forecast location on each of the plurality of dates that include and immediately precede the forecast date are identified by:
determining whether the atmospheric pressure is stable by comparing the difference between the maximum atmospheric pressure and the minimum atmospheric to a predetermined pressure threshold; and
determining whether the atmospheric pressure is rising or falling by comparing the time of the maximum atmospheric pressure and time of the minimum atmospheric.

14. The system of claim 13, wherein the atmospheric pressure conditions in the forecast location on each of the plurality of dates that include and immediately precede the forecast date further are further identified by:
determining whether the atmospheric pressure is rising early or late by comparing the time of the maximum atmospheric pressure to a predetermined threshold time.

15. The system of claim 11, wherein the calculated pressure adjustment is calculated by adding each of the identified pressure components for each of the plurality of dates that include and immediately precede the forecast date.

16. The system of claim 11, wherein the pressure adjustment is further calculated by:
comparing the calculated pressure adjustment to an upper limit and a lower limit;
limiting the pressure adjustment to conform to a range between the upper limit and the lower limit.

17. The system of claim 11, wherein the identified sky adjustment is identified by:
selecting a predetermined temperature-based sky adjustment in response to a determination that the past temperature metric for the forecast location and the forecast date is equal to or exceeds a predetermined temperature threshold;
selecting a predetermined sky adjustment associated with the forecasted sky condition and/or the forecasted precipitation condition in the forecast location on the forecast date in response to a determination that the past temperature metric for the forecast location and the forecast date is not equal to or exceed the predetermined temperature threshold.

18. The system of claim 11, wherein the bass forecast rating is further calculated by:
comparing the calculated bass forecast rating to a predetermined maximum forecast rating; and
selected limiting the predetermined maximum bass forecast rating in response to a determination that the calculated bass forecast rating exceeds the predetermined maximum bass forecast rating.

19. The system of claim 11, wherein:
the hardware computer processing unit is further configured to identify a moon adjustment by calculating a difference between the forecast date a lunar event in the forecast location and identifying the moon adjustment based on the calculated difference between the forecast date the lunar event in the forecast location; and
the identified base rating is further adjusted based on the identified moon adjustment.

20. The system of claim 19, wherein the bass forecast rating is calculated by:
multiplying the sum of the identified base rating, the identified moon adjustment, and the identified past temperature adjustment by the sum of the identified sky adjustment, the identified wind adjustment, the calculated past change adjustment, and the calculated pressure adjustment; and
adding the sum of the identified base rating, the identified moon adjustment, and the calculated past temperature adjustment.
